(19) United States
(12) Patent Application Publication
(10) Pub. No.: US 2007/0018946 A1
(43) Pub. Date: Jan. 25, 2007

(54) Controller apparatus

(76) Inventors: Kevin Manley, Daytona Beach, FL (US); Omar Haddad, Daytona Beach, FL (US)

Correspondence Address: THE WATSON INTELLECTUAL PROPERTY GROUP, PLC, 3133 HIGHLAND DRIVE, SUITE 200, HUDSONVILLE, MI, 49426, US

(21) Appl. No.: 11/169,146

(22) Filed: Jun. 28, 2005

Related U.S. Application Data
(63) Continuation-in-part of application No. 10/952,467, filed on Sep. 28, 2004.

(51) Int. Cl. G09G 5/00

(52) U.S. Cl. 345/156

(57) ABSTRACT

A controller comprising a body, a mouse assembly, a gamepad assembly and a connector. The mouse assembly extends from the body, is recognizable by a personal computer as a mouse assembly, and includes a pointer device and at least one mouse button. The gamepad assembly extends from the body, is recognizable by a personal computer as a gamepad assembly, and includes at least one of a thumbstick and a directional pad. The connector is capable of providing a connection between each of the mouse assembly, the gamepad assembly and the button subassembly with a personal computer.

### CROSS-REFERENCE TO RELATED APPLICATION

The present application is related to U.S. application Ser. No. 10/952,467 filed Sep. 28, 2004, entitled Controller Apparatus, the entirety of which is hereby incorporated by reference.

### BACKGROUND OF THE INVENTION

1. Field of the Invention

The present invention relates in general to an input device for a computer and the like, and more particularly, to a controller apparatus for use in association with, primarily, a personal computer.

2. Background Art

Computer users typically utilize two input devices for most productivity applications. These include a conventional keyboard and a mouse. Keyboards generally include in excess of a hundred buttons. Mice (or other pointing devices) are generally separate devices although in certain embodiments, a trackpad or pointing device can be combined with a keyboard. In certain applications, additional input devices are utilized, such as, for example, number pads and digitizing pads.

Depending on the games, computer gamers generally utilize two different input methods. The first one involves the use of a gamepad. A gamepad generally includes one or more thumbsticks, directional pads and trigger buttons. The other includes extensive use of several buttons of a keyboard in addition to a mouse.

The operating system of most personal computers recognize keyboards, pointing devices and game controllers automatically upon association with the personal computer, without additional software. As such, the devices perform the intended tasks when they are first plugged into the personal computer. While certain of these devices may include additional software so as to provide additional functionality, such software is not generally required for basic operation.

While such input devices have been widely accepted, there are many instances where the shortcomings of the foregoing devices limits the user. For example, with certain applications, a user requires a mouse and a limited number of keys or buttons. In such an application, the user nevertheless must utilize a mouse and an entire keyboard—even though much of the keyboard is not utilized by the user. Additionally, certain games require the use of a keyboard, while only a few keys are actually necessary.

In other instances, the user may wish to utilize a mouse controller for certain functions while utilizing a game controller for other functions. Typically, to achieve such functionality, a user must utilize both a mouse and a gamepad. While some devices include additional software to have a gamepad mimic a mouse, such software limits the applicability of the controller with any personal computer—unless the special software is first installed.

Accordingly, it is an object of the present invention to provide a controller apparatus which includes a mouse, a joystick/gamepad in a single device.

It is another object of the invention to provide a controller which is identified by a conventional personal computer as each of a mouse and a gamepad optionally having a button subassembly.

It is another object of the invention to provide a controller which facilitates the operation of a number of functions for a particular application with an overlay that identifies such functions.

It is another object of the invention to provide a controller which provides an enhanced experience with respect to input and control of a number of different applications.

These and other objects of the invention will become apparent in light of the specification and claims appended hereto.

### SUMMARY OF THE INVENTION

The invention comprises a controller. The controller comprises a body, a mouse assembly, a gamepad assembly and connector. The mouse assembly extends from the body. The mouse assembly is recognizable by a personal computer as a mouse assembly, and includes a pointer device and at least one mouse button. The gamepad assembly extends from the body. The gamepad assembly is recognizable by a personal computer as a gamepad assembly, and includes at least one of a thumbstick and a directional pad. The connector is capable of providing a connection between each of the mouse assembly and the gamepad assembly with a personal computer.

In a preferred embodiment, the mouse assembly further includes at least one button associated with the mouse whereupon actuation of the at least one button configures a portion of the mouse assembly (i.e., the trackball or other pointing device) as being recognizable by a personal computer as a second thumbstick of a gamepad assembly.

In another embodiment, the pointer device comprises a trackball. Preferably, the trackball comprises an optical trackball.

Preferably, the at least one mouse button comprises at least two mouse buttons. Further, it is contemplated that a preferred embodiment include a scroll wheel.

In a preferred embodiment, the controller further comprises a button subassembly associated with the gamepad assembly. The button subassembly includes a plurality of buttons. In one embodiment, at least one of the plurality of buttons of the button subassembly further include an indicator so as to identify the status of the function actuated by the at least one of the plurality of buttons having the indicator.

In one such embodiment, the gamepad assembly includes at least one thumbstick, at least one directional pad and at least one button.

In a preferred embodiment, the controller further comprises an overlay positionable upon the body, the overlay providing an identification as to the function of at least one of the buttons of the button subassembly. In one embodiment, the overlay assembly is sized so as to substantially correspond to a conventional DVD/CD-ROM case.

In one preferred embodiment, the overlay provides an identification as to the function of at least one of the buttons of the button subassembly, at least one function of the gamepad assembly and at least one function of the mouse assembly.

In another preferred embodiment, the controller further comprises a configuration file which is downloadable from an outside source. In one such embodiment, the controller further comprises means for automatically downloading the configuration file from an outside source.

In yet another preferred embodiment, the controller further comprises means for determining an active window on a personal computer; and means for selecting a desired configuration file based upon the determined active window.

In a preferred embodiment, the connector comprises a single connector in the form of at least one of a wire connector and a wireless connector.

Preferably, the connector comprises a wire connector having a USB connector. Alternatively, the connector comprises a wireless connector operating under any one or more of a RF, Bluetooth and WiFi protocol.

In a preferred embodiment, the housing includes opposing handle regions to facilitate the handling and retention in a handheld orientation.

In a preferred embodiment, the mouse assembly of the controller further includes a sticky button which is associated with the at least one mouse button of the mouse assembly.

### BRIEF DESCRIPTION OF THE DRAWINGS

The invention will now be described with reference to the drawings wherein:

FIG. 1 of the drawings comprises a perspective view of the controller of the present invention; and

FIG. 2 of the drawings comprises a schematic representation of the controller of the present invention.

### DETAILED DESCRIPTION OF THE INVENTION

While this invention is susceptible of embodiment in many different forms, there is shown, in the drawings, several specific embodiments with the understanding that the present disclosure is to be considered as an exemplification of the principles of the invention and is not intended to limit the invention to the embodiments illustrated.

It will be understood that like or analogous elements and/or components, referred to herein, are identified throughout the drawings by like reference characters. In addition, it will be understood that the drawings are merely representations of the present invention, and some of the components may have been distorted from actual scale for purposes of pictorial clarity.

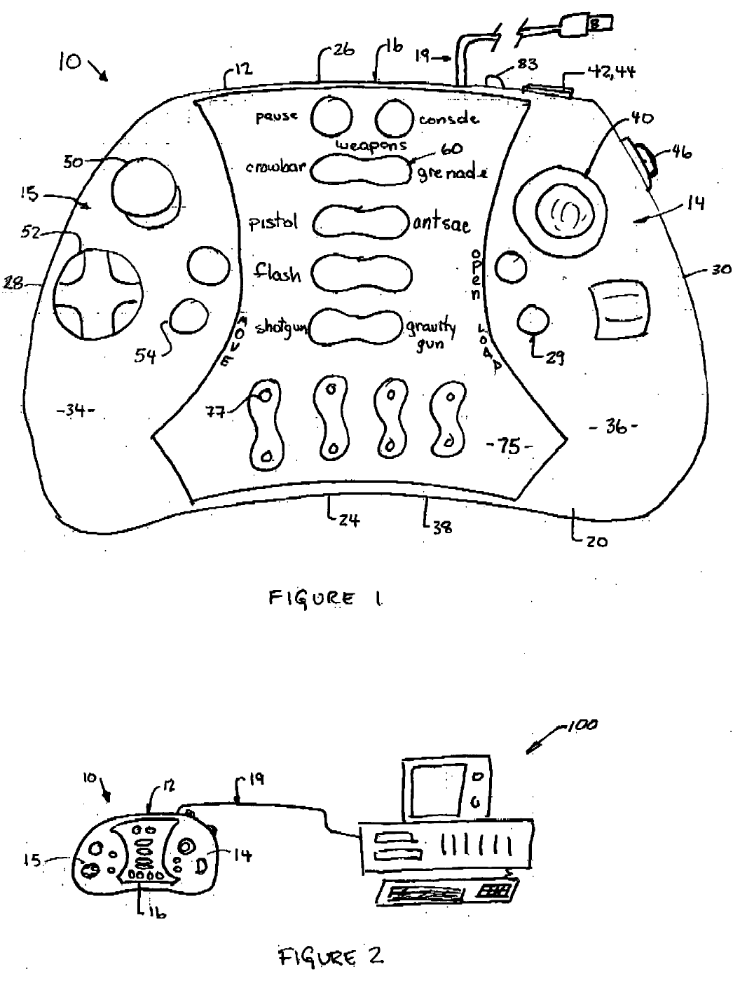

Referring now to the Figures, and in particular to FIGS. 1 and 2, the controller of the present invention is shown generally at 10. The controller is suitable for use in association with a personal computer (such as a computer utilizing any one of the operating systems of Windows, Linux and MacOS, among others). The controller is particularly useful for a number of different personal computer games, wherein various combinations of a mouse, a keyboard and a gamepad are useful. Of course, the controller is not limited for use in association with the foregoing.

Controller 10 is shown in FIGS. 1 and 2 as including housing 12, mouse assembly 14, gamepad assembly 15 having button sub-assembly 16, connector assembly 19. The controller is generally sized so as to be hand held by a user and to be easily held and manipulated by a user in free space. Of course, it is not limited to such a configuration or usage.

More specifically, housing 12 is shown as comprising upper surface 20 and lower surface opposite the top surface (not shown). The upper surface is substantially planar, but is not limited to such a configuration. The upper surface includes an overlay region 38 configured to receive any number of custom overlays which may be configured for use with the controller. The upper and lower surfaces are separated from each other a predetermined distance by sides. The sides include first side surface 28 and second side surface 30, back surface 24 and front surface 26. At an upper end, the sides terminate proximate the top surface. At a lower end, the sides terminate proximate the bottom surface. The housing can be formed from a polymer through a casting or molding process, which will be understood by those of skill in the art.

Portions of the sides and the upper and lower surfaces form first handle region 34 and second handle region 36 which is positioned so as to oppose first handle region 34. In the embodiment shown, the housing is substantially symmetrical about a longitudinal axis extending between the first and second handle regions. The handle regions facilitate the grasping and retention of the controller with maximum comfort.

Mouse assembly 14 is shown in FIG. 1 as comprising pointer 40 (such as a trackball), first mouse button 42, second mouse button 44 and scroll wheel 46. Pointing device 40 most preferably comprises a conventional optical or mechanical trackball, as trackballs have a certain advantage with respect to certain gaming application. It is contemplated that number of different pointing devices may be utilized in place of a trackball, such as a pointer, a glide pad, among others. The first and second mouse button s 42, 44 comprise quick hit buttons. Scroll wheel 46 comprises any number of different scroll wheels which convert mechanical rotation to a electronic signal which can be interpreted. In the present embodiment, the first and second mouse buttons are position in orientations commonly utilized for trigger buttons on a conventional gamepad (i.e., front surface 26), the scroll wheel is positioned along side surface 30 and the trackball is positioned on upper surface 20. Of course, it will be understood that the various components of the mouse assembly may be positioned on the various surfaces as desired. Through the use of conventional identification protocols, the mouse assembly is configured so as to be interpreted as a mouse by a personal computer (i.e., plug and play conventions).

In one embodiment, the mouse assembly may include a button, such as button 29, which facilitates a sticky button feature. It will be understood that a sticky button feature comprises a separate button which, when in an activated condition has the effect of electrically maintaining the mouse button in a pressed condition (electrically, and regardless of the mechanical position of the mouse button) after a first pressing of the mouse button until the mouse is pressed again, or until the stick mouse feature is deactivated. Such a configuration is useful for a number of different games and for certain productivity applications.

Gamepad assembly 15 is shown in FIG. 1 as comprising thumbstick 50, directional pad 52 and trigger buttons, such as trigger buttons 54. Thumbstick 50 generally comprises an analog stick typically associated with gamepads. In other embodiments, the thumbstick may comprise a digital input device. Directional pad 52 comprises a disc like (or cross-like) pad which facilitates directional input in at least four and more preferably at least 16 directions. Trigger buttons 54 comprise a number of buttons which are positioned about the controller. These trigger buttons are positioned for articulation by the thumbs and/or index fingers of the user. Typically, certain of these buttons are positioned proximate the front surface, the top surface or the lower surface of the controller, however, other placement options are likewise contemplated. Indeed, the invention is not limited to any particular positioning of the various buttons and components of the gamepad. Through the use of conventional identification protocols, the gamepad assembly is configured so as to be interpreted as a game pad by a personal computer (i.e., plug and play conventions).

Button sub-assembly 16 (a portion of the gamepad assembly 15) is shown in FIG. 1 as comprising a plurality of buttons, such as buttons 60. These different buttons are positioned on upper surface 20 of housing 12. The buttons may comprise any one of a number of different constructions, including, but not limited to an elastomeric button, a conventional keyboard key, a bubble or another means by which to create a momentary connection through actuation. Through the use of conventional identification protocols, the button subassembly is configured so as to be interpreted as a portion of the gamepad (i.e., plug and play conventions). Certain of the buttons may include means 77 for identifying the status of the buttons, which identifying means may be in the form of an illumination or differences in position. For example, each time the button is actuated, the button can vary between an illuminated condition and a non-illuminated condition. Through software, the buttons of the button subassembly can be assigned to various features.

The outside connecting means 19 is shown in FIG. 3 as comprising a USB connector which is capable of being associated with the game controller circuitry at its first end, and being coupled to a USB port on the hardware at the second end. In other embodiments output 16 may comprise a RF communication subassembly, or a system communicating under various protocols, such as, for example, Bluetooth, WiFi, etc. Of course, any number of different manners in which to communicate the signals directed from the various user input devices to the hardware device are contemplated for use, and the invention is not limited to use in association with any one particular output.

Critically, and with reference to FIG. 2, utilizing standard plug and play convention, when the controller is plugged into or otherwise associated with a personal computer 100, the controller is “identified” by the operating system of the personal computer as a mouse assembly and a gamepad assembly (having a user configurable button subassembly). In particular, the mouse assembly 14 is interpreted as a conventional two button mouse, the gamepad assembly 15 is interpreted as a conventional gamepad and the button is interpreted as a portion of the gamepad. As such, the single device is functionally (in combination with a personal computer) a mouse, a gamepad (having a button subassembly) combined in a single device. Affirmative steps must be taken by a user to alter such a configuration.

After recognition of the device, the user may whish to utilize the mouse assembly as a second thumbstick. To facilitate same, after recognition of the device, a button, such as button 83 is provided. In a first position, i.e., a non-actuated position, the mouse operates in the conventional manner as described above. In the actuated position, trackball 40 is configured so as to be identified as a conventional right thumbstick. Such right thumbsticks are utilized in a number of different games. In a configuration wherein the trackball (or other pointing device) is intended for use as a second thumbstick, as the controller senses that the trackball has not moved for a predetermined period of time (i.e., a few milliseconds), the second thumbstick is reset to zero (so as to mimic a centrally located thumbstick in a resting position). When the trackball is moved beyond that which could be achieved by a second thumbstick, the data saturates and is maintained at what would be considered maximum deflection of a second thumbstick. The user can toggle between the recognition of the trackball (or other pointing device) as a second thumbstick or a portion of a mouse assembly.

For certain applications, a number of buttons or button combinations may be required. These buttons or button combinations can be assigned to the individual buttons of the button subassembly or the remainder of the gamepad assembly. Such assignment can be manually executed by the user through the personal computer. In other embodiments, a file may be uploaded into the personal computer which automatically assigns the buttons for a particular application. It is contemplated that configuration files can be provided on the Internet or otherwise for any number of different applications and games. Such a configuration file assists the user with the quick customization of the device to a particular application. In certain embodiments, a software utility can be installed such that the configuration files are downloaded automatically based upon programs that appear on the particular personal computer, or particular applications that are utilized by the personal computer (i.e., automatic downloading means). In still other embodiments, the software can be configured so as to automatically switch between configurations based upon the application that is in the current or active window. The software provides a means for determining an active window on a personal computer and means for selecting a desired configuration based upon the determined active window. In this manner the user can switch between configuration files such that the controller performs in a desired manner based upon the active application at any given time.

Overlay 75 may be provided to identify to the user the function of each of the different functional members of the mouse assembly, the gamepad assembly and the button subassembly. The overlay may comprise a paperboard or plastic member which is releasably attachable to the controller in a number of different orientations. In other embodiments, the overlay may comprise a sticker which is applied to the controller. The overlay is cut in such a manner that facilitates proper placement by the user. In the present example, the overlay identifies the function of a number of the buttons of the button subassembly and certain buttons of the mouse assembly.

In certain embodiments, the overlay may have a plurality of orientations. For example, overlay 75 may include a first side and a second side. On the first side, the purpose of each of the functional members can be identified for offensive control of a game (i.e., offense in football). On the second side, the purpose of each of the functional members can be identified for defensive control of a game (i.e., defense in football). Overlays can be utilized for games, applications and other types of software. Indeed, a number of overlays can be provided for a number of different software products commercially available. In addition, templates can be provided which allow a user to custom make an overlay for a particular application. It is contemplated that the overlay may be sized so as to fit within a DVD/CD-ROM case, such that it can be packaged together with gaming or application software generally shipped and sold in such a case.

Overlays can be provided for a number of different games as well as for productivity software. For example, certain software, such as, browsing requires a few keys and a mouse. Thus, instead of utilizing a conventional keyboard and mouse, the user can sit back and utilize a single controller apparatus of the present invention. Furthermore, in certain presentations, such as PowerPoint, the user may find it advantageous to utilize a controller which includes functions in excess of a conventional mouse.

The foregoing description merely explains and illustrates the invention and the invention is not limited thereto except insofar as the appended claims are so limited, as those skilled in the art who have the disclosure before them will be able to make modifications without departing the scope of the invention.

What is claimed is:

1. A controller comprising:
a body;
a mouse assembly extending from the body, the mouse assembly recognizable by a personal computer as a mouse assembly, and including a pointer device and at least one mouse button;
a gamepad assembly extending from the body, the gamepad assembly recognizable by a personal computer as a gamepad assembly, and including at least one of a thumbstick and a directional pad; and
a connector capable of providing a connection between each of the mouse assembly and the gamepad assembly with a personal computer.

2. The controller of claim 1 wherein the mouse assembly further includes at least one button associated with the mouse whereupon actuation of the at least one button configures the pointer device of the mouse assembly as being recognizable by a personal computer as a right thumbstick of a gamepad assembly.

3. The controller of claim 1 wherein the pointer device comprises a trackball.

4. The controller of claim 3 wherein the trackball comprises an optical trackball.

5. The controller of claim 1 wherein mouse assembly further includes a scroll wheel.

6. The controller of claim 1 further comprising a button subassembly associated with the gamepad assembly, the button subassembly having a plurality of buttons.

7. The controller of claim 6 wherein at least one of the plurality of buttons of the button subassembly further include an indicator so as to identify the status of the function actuated by the at least one of the plurality of buttons having the indicator.

8. The controller of claim 1 wherein the gamepad assembly includes at least one thumbstick, at least one directional pad and at least one button.

9. The controller of claim 1 further comprising an overlay positionable upon the body, the overlay providing an identification as to the function of at least one of the buttons of the button subassembly.

10. The controller of claim 9 wherein the overlay provides an identification as to the function of at least one of the buttons of the button subassembly, at least one function of the gamepad assembly and at least one function of the mouse assembly.

11. The controller of claim 9 wherein the overlay is configured so as to substantially correspond to a conventional DVD/CD-ROM case.

12. The controller of claim 1 further comprising a configuration file which is downloadable from an outside source.

13. The controller of claim 12 further comprising means for automatically downloading the configuration file from an outside source.

14. The controller of claim 1 further comprising:
means for determining an active window on a personal computer; and
means for selecting a desired configuration file based upon the determined active window.

15. The controller of claim 1 wherein the connector comprises a single connector in the form of at least one of a wire connector and a wireless connector.

16. The controller of claim 15 wherein the connector comprises a wire connector having a USB connector.

17. The controller of claim 15 wherein the connector comprises a wireless connector operating under any one or more of a RF, Bluetooth and WiFi protocol.

18. The controller of claim 1 wherein the housing includes opposing handle regions to facilitate the handling and retention in a handheld orientation.

19. The controller of claim 1 wherein the mouse assembly further includes a sticky button which is associated with the at least one mouse button of the mouse assembly.
